(19) United States
(12) Patent Application Publication
(10) Pub. No.: US 2013/0088792 A1
(43) Pub. Date: Apr. 11, 2013

(54) MOUNT FOR REARVIEW MIRROR

(71) Applicants: Nigel G. Jones, Orion, MI (US); Nicholas P. Nagrant, Farmington Hills, MI (US); Michael J. Tanner, La Salle (CA)

(72) Inventors: Nigel G. Jones, Orion, MI (US); Nicholas P. Nagrant, Farmington Hills, MI (US); Michael J. Tanner, La Salle (CA)

(73) Assignee: GM GLOBAL TECHNOLOGY OPERATIONS LLC, DETROIT, MI (US)

(21) Appl. No.: 13/269,635

(22) Filed: Oct. 10, 2011

(51) Int. Cl. B60R 1/04

(52) U.S. Cl. 359/872

(57) ABSTRACT

A mount for a rearview mirror includes a base having a bottom surface for adhesive attachment to a windshield glass, a top surface, opposed side surfaces with dovetail walls, and end walls. A mirror mount has dovetail engaging sidewalls that slide onto the dovetail walls of the base. A locking lever is pivotally mounted on the mirror mount and has a cam surface thereon that swings into engagement with the top surface of the base to lock the mirror mount against sliding movement on the base so that the mirror mount is thereby mounted on the base. The locking lever has a handle portion that is flush with a surface of the mirror mount when the cam surface of the locking lever engages with the top surface to provide tactile and visible feedback that the mirror has been properly mounted on the base.

### FIELD OF THE INVENTION

The present invention relates to mounting an inside rearview mirror on the windshield glass in a motor vehicle and more particularly provides an improved dovetail mounting assembly having a lever operated locking cam.

### BACKGROUND OF THE INVENTION

Motor vehicles are typically equipped with an inside rearview mirror that is mounted on the windshield so that the driver can observe traffic behind the vehicle. The inside rearview mirror typically includes a mirror glass enclosed in a mirror housing. The housing has a spherical receptacle for mounting on a ball swivel so that the position of the inside rearview mirror can be readily adjusted by the driver.

In the vehicle assembly plant, a metal or plastic base having dovetail walls is adhered to the windshield by tape or a bead of adhesive. A mirror mount, typically of molded plastic has a swivel ball that snaps into the spherical receptacle of the mirror housing. The mirror mount also has dovetail engaging sidewalls that slide over the dovetail walls of the base. A set screw is typically provided on the mirror mount and is tightened into engagement with the base so that the inside rearview mirror is retained on the windshield.

It would be desirable to provide a new and improved mount for an inside rearview mirror that would provide improvements in ease of assembly of the inside rearview mirror to the windshield.

### SUMMARY OF THE INVENTION

A mount for a rearview mirror includes a base having a bottom surface for adhesive attachment to a windshield glass, a top surface, opposed side surfaces with dovetail walls, and end walls. A mirror mount has dovetail engaging sidewalls that slide onto the dovetail walls of the base. A locking lever is pivotally mounted on the mirror mount and has a cam surface thereon that swings into engagement with the top surface of the base to lock the mirror mount against sliding movement on the base so that the mirror mount is thereby mounted on the base. The locking lever has a handle portion that is flush with a surface of the mirror mount when the cam surface of the locking lever engages with the top surface to provide tactile and visible feedback that the mirror is properly mounted on the base.

Further areas of applicability of the present invention will become apparent from the detailed description provided hereinafter. It should be understood that the detailed description and specific examples, while indicating exemplary embodiments of the invention, are intended for purposes of illustration only and do not limit the scope of the invention.

### BRIEF DESCRIPTION OF THE DRAWINGS

The present invention will become more fully understood from the detailed description and the accompanying drawings, wherein:

FIG. 1 is a perspective view of a first embodiment of the invention having parts broken away and in section.

FIG. 2 is a perspective view of a second embodiment of the invention having parts broken away and in section.

FIG. 3 is a perspective view of a third embodiment of the invention having parts broken away and in section.

### DETAILED DESCRIPTION OF THE EXEMPLARY EMBODIMENTS

The following description of certain exemplary embodiments is merely exemplary in nature and is not intended to limit the invention, its application, or uses.

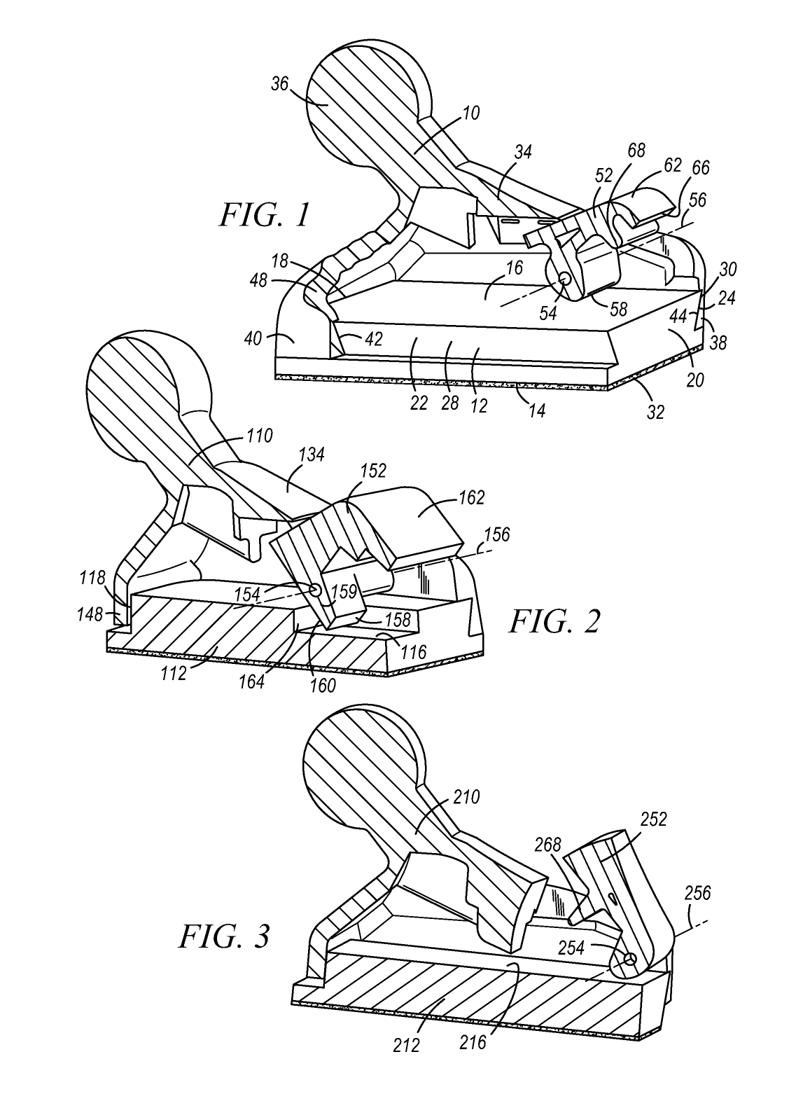

As seen in FIG. 1, a mirror mount 10 and a mirror base 12 are provided for mounting an inside rearview mirror on a motor vehicle.

The base 12 can be of molded plastic or metal construction and includes a bottom surface 14 that will face a windshield glass, a top surface 16 opposite the bottom surface 14, a pair of end walls 18 and 20, and sidewalls 22 and 24. The sidewalls 22 and 24 angle away from one another to provide dovetail sidewalls 28 and 30. A piece of tape 32, or a bead of adhesive, will adhere the bottom surface 14 of the base 12 to the windshield glass.

The mirror mount 10 is of molded plastic or metal construction and has a top wall 34 that includes a spherical ball 36. A pair of sidewalls 38 and 40 depend downwardly from the top wall 34. The sidewalls 38 and 40 provide dovetail engaging sidewalls 42 and 44 that are precisely spaced apart and are angled relative one another so as to engage the dovetail sidewalls 28 and 30 when the mirror mount 10 is slid onto the base 12. The mirror mount 10 also includes an end wall 48 that depends from the top wall 34 and will engage with the end wall 18 of base 12 to stop the sliding movement of the mirror mount 10 onto the base 12.

The mirror mount 10 includes a locking lever 52 that is mounted on the mirror mount 10 by a pivot shaft 54 so that the lever 52 is pivotally mounted for movement about a pivot axis 56. The locking lever 52 has a cam surface 58 that swings about the pivot 54 with the locking lever 52 and thereby moves between an unlocking position shown in FIG. 1, and a locking position. The locking position is obtained by pressing downwardly on a handle portion 62 of the lever 52 so that the cam surface 58 is forcibly engaged with the top surface 16 of the base 12 and thereby lifts the dovetail engaging walls 42 and 44 of the mirror mount 10 upwardly away and into engagement with the dovetail walls 28 and 30 of the base 12.

In the locked position, the cam surface 58 will preferably go slightly over center with respect to the pivot shaft 54 so as to provide a biasing and tensioning force between the mirror mount 10 and the base 12. The pivot shaft 54 can also have sufficient flexibility to provide a biasing and tensioning force. Or, the dovetail sidewalls 42 and 44 of the mirror mount 10 can have sufficient flexibility to provide the biasing and tensioning force.

When the locking lever 52 has reached its locking position, an end wall 66 of the handle portion 62 will engage with the top surface 16 of the base 12 in order to stop the locking lever 52 against further pivoting movement. Alternatively, an abutment 68 provided on the underside of the handle portion 62 will engage with the top surface 16 of the base 12 in order to stop the locking lever 52 against further pivoting movement.

In addition, when the locking lever 52 has reached its locking position, the handle portion 62 will be flush with the surface of the top wall 34 thereby providing a tactile and visible feedback to the installer that the fully locked and installed position has been obtained. In addition, if the fully flush condition is not obtained, the resulting unflush condition of the handle portion 62 will inform the installer that the installation has not been properly accomplished, and the installer can then take corrective action to achieve a fully proper installation.

FIG. 2 is another embodiment of the invention and differs in the shape of the cam surface provided on locking lever 152. In particular, in FIG. 2, the locking lever 152 has a cam surface 158 that is flat instead of the rounded cam shape 58 that had been employed in FIG. 1. In the locked condition of the embodiment of FIG. 2, the flat cam surface 158 will be engaged with top surface 116 of base 112, and this engagement of the flat cam surface 158 with the flat top surface 116, will serve to lock the locking lever 152 in its fully locked position. In addition, the locking lever 152 has an abutment leg 159 with a backside surface 160 that will engage with an abutment wall 164 of the base 112 to assure that mirror mount 110 has been slid onto the base 112 sufficiently for end wall 148 of the mirror mount 110 to have engaged with end wall 118 of the base 112. As in FIG. 1, when the locking lever 152 reaches its fully locked position, handle portion 162 will become flush with top wall 134 of mirror mount 110 to provide visible and tactile feedback that the locked condition has been obtained.

FIG. 3 shows yet another embodiment of the invention and differs from FIG. 1 in the direction of the pivotal movement of locking lever 252. In FIG. 3, pivot 254 is located at the far end of mirror mount 210, so that the locking lever 252 will pivot counterclockwise about its axis of rotation 256, as opposed to FIG. 1, where the locking lever 52 rotates clockwise about axis 56. The underside of the locking lever 252 has an abutment 268 that will engage with top surface 216 of base 212 to limit the pivoting of the locking lever 252 about the pivot axis 256.

Thus, it is seen that the invention has provided a new and improved device for mounting an inside rearview mirror on the windshield of a vehicle. No set screw is required to attach the mirror mount to the mirror base, and, instead, a cam locking system is provided that will reliably maintain tension and biasing between the mirror mount and the base, while also giving immediate tactile and visible feedback to the assembly plant installer that a proper installation has or has not been achieved.

What is claimed is:

1. A mount for a rearview mirror comprising:
a base having a bottom surface for adhesive attachment to a windshield glass, a top surface, opposed side surfaces with dovetail walls, and end walls;
a mirror mount having a swivel ball on which the mirror is mounted, dovetail engaging sidewalls that slide onto the dovetail walls of the base, and a locking lever pivotally mounted on the mirror mount and having a cam surface thereon that swings into engagement of the top surface of the base to lock the mirror mount against sliding movement on the base so that the mirror mount is thereby mounted on the base.

2. The mount of claim 1 further comprising the locking lever having a handle portion that is flush with a surface of the mirror mount when the cam surface of the locking lever engages with the top surface to provide tactile and visible feedback that the mirror is properly mounted on the base.

3. The mount of claim 1 further comprising the locking lever being mounted on the mirror mount for clockwise rotation.

4. The mount of claim 1 further comprising the locking lever being mounted on the mirror mount for counterclockwise rotation.

5. The mount of claim 1 further comprising the cam surface being a rounded surface.

6. The mount of claim 1 further comprising the cam surface being a flat surface.

7. The mount of claim 1 further comprising the cam surface going over center with respect to a pivot.

8. The mount of claim 1 further comprising the locking lever having a wall that engages with an abutment wall on the base to limit the pivoting movement of the locking lever.

9. The mount of claim 1 further comprising the locking lever having an abutment that engages with the top surface of the base to limit the pivoting movement of the locking lever.

10. The mount of claim 1 further comprising the locking lever having a handle potion that is flush with a surface of the mirror mount when the cam surface of the locking lever is engaged with the top surface to provide tactile and visible feedback that the mirror is thereby mounted on the base, and the locking lever having one of a wall, a surface, or an abutment, engaging with the base to limit the pivoting movement of the handle portion and stop the handle portion at the position flush with the surface of the mirror mount.

11. A mount for a rearview mirror comprising:
a base having a bottom surface for adhesive attachment to a windshield glass, a top surface, opposed side surfaces with dovetail walls, and end walls;
a mirror mount having a swivel ball on which the mirror is mounted, dovetail engaging sidewalls that slide onto the dovetail walls of the base, and a locking lever pivotally mounted on the mirror mount and having a cam surface thereon that swings into engagement with the top surface of the base to lock the mirror mount against sliding movement on the base so that the mirror mount is thereby mounted on the base, and said locking lever having a handle portion that is flush with a surface of the mirror mount when the cam surface of the locking lever is engaged with the top surface to provide tactile and visible feedback that the mirror is mounted on the base.

12. The mount of claim 11 further comprising the cam surface being a rounded surface.

13. The mount of claim 11 further comprising the cam surface being a flat surface.

14. The mount of claim 11 further comprising the cam surface going over center with respect to a pivot.

15. The mount of claim 11 further comprising the locking lever having a wall that engages with an abutment on the base to limit the pivoting movement of the locking lever.

16. The mount of claim 11 further comprising the locking lever having an abutment that engages with the top surface of the base to limit the pivoting movement of the locking lever.

17. A mount for a rearview mirror comprising:
a base having a bottom surface for adhesive attachment to a windshield glass, a top surface, opposed side surfaces with dovetail walls, and end walls;
a mirror mount having a swivel ball on which the mirror is mounted, dovetail engaging sidewalls that slide onto the dovetail walls of the base, and a locking lever pivotally mounted on the mirror mount and having a cam surface thereon that swings into engagement of the top surface of the base to lock the mirror mount against sliding movement on the base so that the mirror mount is thereby mounted on the base, and said locking lever having a handle potion that is flush with a surface of the mirror mount when the cam surface of the locking lever is engaged with the top surface to provide tactile and visible feedback that the mirror is thereby mounted on the base, and the locking lever having one of a wall, a surface, or an abutment, engaging with the base to limit the pivoting movement of the handle portion and stop the handle portion at its position flush with the surface of the mirror mount.

18. The mount of claim 17 further comprising the cam surface being a rounded surface.

19. The mount of claim 17 further comprising the cam surface being a flat surface.

20. The mount of claim 17 further comprising the cam surface going over center with respect to a pivot.
